(19) United States
(12) Patent Application Publication
(10) Pub. No.: US 2003/0151763 A1
(43) Pub. Date: Aug. 14, 2003

(54) Method and device for the request of data required for the execution of operations at a technical installation

(76) Inventor: Siegmund Kocma, Wiesenttal (DE)

Correspondence Address: SIEMENS SCHWEIZ, I-44, INTELLECTUAL PROPERTY, ALBISRIEDERSTRASSE 245, ZURICH, CH-8047, CH

(21) Appl. No.: 10/347,437

(22) Filed: Jan. 21, 2003

(30) Foreign Application Priority Data
Jan. 29, 2002 (DE) 10203369.2

(51) Int. Cl. B41F 1/00

(52) U.S. Cl. 358/1.14

(57) ABSTRACT

The invention concerns a method and a device for the request of data (13a) required for an execution of operations at a technical installation (1). If for example a technician (12) requires additional information regarding the technical installation (1) during his operations at the technical installation (1), he contacts with a first communication terminal (5, 15, 16, 17) a central computer (6) and transmits it his identity, data regarding the technical installation (1) and an address of a second communication terminal (15, 16, 17). The central computer (6) then requests at least a part of the data record (13a) stored in a database (13) and associated to the technical installation, to transmit the record to the second communication terminal (15, 16, 17).

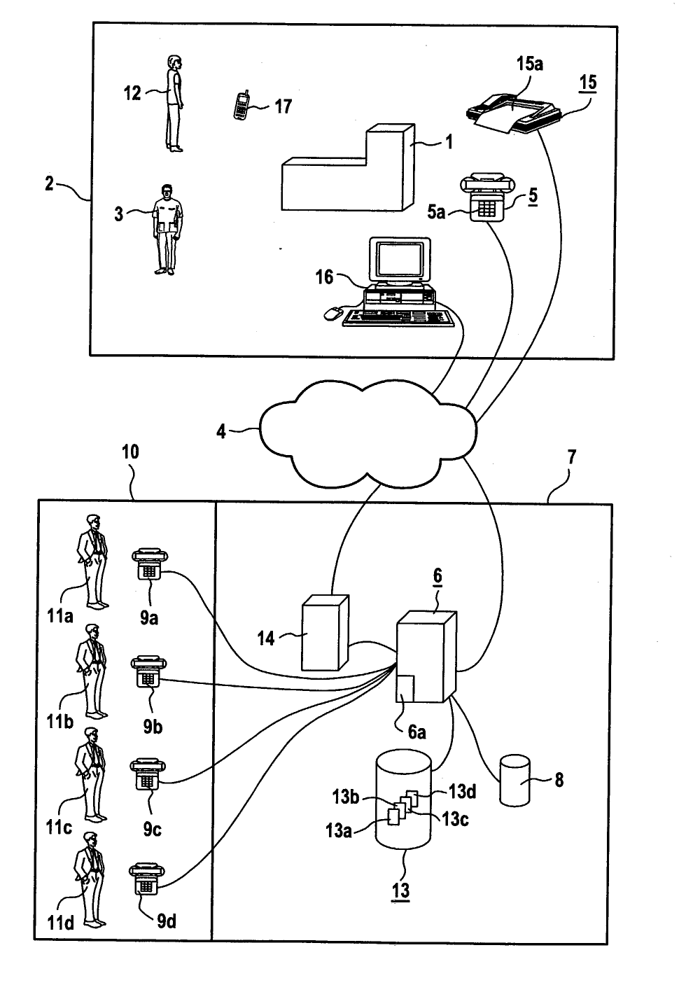

### CROSS REFERENCE TO RELATED APPLICATIONS

The present application claims priority to German patent application number 10203369.2, filed Jan. 29, 2002 which is herein incorporated by reference.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISK APPENDIX

Not applicable.

### BACKGROUND OF THE INVENTION

The invention concerns a method and a device for the request data required for the execution of operations at a technical installation.

Particularly a technical facility, as for example a transporting installation, or a technical device, as for example a medico-technical device, is meant by a technical installation. Especially a carried-out service or maintenance, an initiation or operation related to repairing failures of the technical installation.

At times, a technician who operates at the technical installation requires additional, for the execution of the operations necessary information about the technical installation, which are not available to him at the location of the technical installation. Such information is for example technical data of the technical installation like for example circuit diagrams, construction drawings or details of the settings or tests to be carried out at the technical installation. Without knowledge of this information, it is aggravating or impossible for the technician to continue or finish the operations at the technical installation. To procure the required information, the technician needs to interrupt his operations, to for example request records comprehending the information from, for instance, his office. This is relatively time consuming particularly then, when his office or the location, where there are his records, are far from the location of the technical installation. The completion of the operation is thereby delayed.

It is therefore the task of the invention to indicate a method with which assistance the person who operates at the technical installation, receives the required information as quickly as possible. It is an additional task of the invention, to realize a device in such a way, that the person operating at the technical installation receives the required information as quickly as possible.

The first task is solved by a method for the request of data required for an execution of operations at a technical installation, showing the following procedure steps:

Contact of a first computer with a first communication terminal by a communication network,

Receipt of data regarding the technical installation, data regarding the operator and an address of a second communication terminal by the first computer,

Request of at least a part of the records corresponding to the technical installation and stored in the database and

Transmission of the part of the records requested from the first computer to the second communication terminal.

The technician, who operates at the technical installation and requires additional information for the further execution of the tasks, can receive these in an easy and convenient manner with the method according to the invention. The technician only needs to contact the first computer with the first communication terminal according to the invention, to transmit to the first computer its identity, the data regarding the technical installation and the address of the second communication terminal. Following this, the first computer automatically determines the required information and transmits it to the second communication terminal. The technician therefore receives the desired information quickly and reliably and can continue operating at the technical installation.

The first communication terminal is preferably a telephone, a fax machine or a second computer which can be connected to a communication network, according to a variant of the invention. Especially at the usage of a telephone as first communication terminal, it is assured, that the technician is able to contact the first computer conveniently. Additionally, phones are easily available.

The second communication terminal is preferably the first fax machine, a second fax machine, a second computer which can be connected to a communication network or a third computer which can be connected to a communication network, according to a design of the invention.

For the identification of the data regarding the technical installation and/or the data regarding the operator by the first computer, it is, according to a preferred variant of the invention, intended, to transmit this data to the first computer by way of an identification which is transmittable with the first communication terminal. This identification can for example be entered by the keys of the telephone as the first communication terminal.

The method according to the invention can be executed particularly conveniently, if, as it is intended according to a preferred design of the invention, the first computer comprises means for the speech analysis, so that the data regarding the technical installation, the data regarding the operator and/or the address of the second communication terminal is transmitted orally to the first computer. The technician therefore needs to only contact the first computer with a telephone and to orally transmit his identity, the data regarding the technical installation and the address of the second communication terminal, to which the requested data has should be sent, if he wants to request the data, meaning the information regarding the technical installation.

To assure, that only authorized persons can request the data, it is intended according to a further variant of the invention that the first computer checks, if a person is authorized to receive the requested data for the execution of the operations at the technical installation.

The second task of the invention is solved by a device for request of data required for the execution of operations at a technical installation, showing

a database, where a data record, which is corresponding to the technical installation, is stored, and

a first computer, which is connectable to the communication network and is contactable to a first communication terminal, which is realized in such a way, that, based on data received from the first communication terminal regarding the technical installation, data regarding the operator and an address of a second communication terminal, it extracts at least a part of the records which are stored in the database and transmits them to the second communication terminal.

The device according to the invention is executed in such a way, that it comprises a first computer which is connectable to the communication network and a database, where data records corresponding to the technical installation are stored. The first computer is realized in such a way, that it can be contacted with the first communication terminal, which for example, as according to a design of the invention, is a telephone, a fax machine or a second computer connectable to the communication network, so that the data regarding the technical installation, the data regarding the operator and the address of the second communication terminal can be communicated to the first computer by the first communication terminal. Furthermore, the first computer is designed in such a way, that, based on this data, it extracts at least a part of the data record stored in the database and transmits it them to the second communication terminal. The device according to the invention is therefore designed in such a way, that the method according to the invention can be implemented with it. Further designs and advantages result from the sub-claims.

### BRIEF DESCRIPTION OF THE SEVERAL VIEWS OF THE DRAWINGS

The novel features and method steps believed characteristic of the invention are set out in the claims below. The invention itself, however, as well as other features and advantages thereof, are best understood by reference to the detailed description, which follows, when read in conjunction with the accompanying drawing. An example of the design is disclosed exemplary in the attached schematic drawings. The figure shows a scenario pictorializing the method according to the invention and the device according to the invention.

### DETAILED DESCRIPTION OF THE INVENTION

The figures show a magnetic resonance device 1, which is located in a physician's practice of a physician 3. In the case of the present example of design, the magnetic resonance device 1 was sold by a manufacturer of various medico-technical devices to the physician 3. The manufacturer offers also computer tomography devices, lithotripter and x-ray devices, not disclosed in the figure, despite the magnetic resonance devices of the type of the magnetic resonance device 1.

In the case of the example of design the magnetic resonance device 1 is disturbed. The physician 3 therefore contacts with his telephone 5 which is connected to a communication network 4, a central computer 6 connected to the communication network 4 of the manufacturer of the magnetic resonance device 1. The central computer 6 is located in a computer room 7 of the manufacturer of the magnetic resonance device 1 in the case of the present example of design.

The central computer 6 comprises in the case of the present example of design generally known means to the specialist for the speech reproduction and speech analysis 6, which are designed in such a way, that they ask the person contacting the central computer 6, in the case of the present example of design therefore the physician 3, for their identity and for the product for which the contacting person needs information.

The central computer 6 is, in the case of the present example of design, additionally connected to a database 8, where the data regarding those persons, who are authorized to request information regarding the products of the manufacturer, is stored. The central computer 6 can therefore check by an appropriate computer program, if a person contacting the central computer 6 is authorized to request information regarding the products of the manufacturer.

The manufacturer of the magnetic resonance device 1 supports furthermore a call center 10, where employees 11a-11d of the manufacturer work with the telephones 9a-9d assigned to them. In the case of the present example of design, the telephone 9a is assigned to the employee 11a. Additionally, the employee 11a is responsible for questions regarding magnetic resonance devices offered by the manufacturer. The employee 11b is responsible for the computer tomography devices. He is assigned to the telephone 9b. The employee 11c is assigned to lithotripter and he is assigned to the telephone 9c. Finally, the employee 11d is responsible for the x-ray devices of the manufacturer. He is assigned to the telephone 9d. This information is stored as well in the database 8.

After the physician 3 communicated his identity to the central computer 6, the central computer 6 checks the authorization of the physician 3. Because in the case of the present example of design, any data regarding the physician 3 is stored in the database 8, the physician 3 is not authorized to request information regarding products of the manufacturer. Because the physician 3 additionally inquires regarding his magnetic resonance device 1, the central computer 6 makes, based on the stored information regarding the employees 11a-11d in the database, a phone connection between the telephone 5 of the physician 3 and the telephone 9a of the employee 11a responsible for the magnetic resonance devices.

After the employee 11a has received the interference message of the physician 3, he sends a technician 12 to the physician's practice 2 of the physician 3, so that he repairs the magnetic resonance device 1.

During the reparation of the magnetic resonance device 1, thus during the carried out labor at the magnetic resonance device 1, the technician 12 finds a problem, which he cannot solve without further information regarding the magnetic resonance device 1. It is therefore impossible for the technician 12, to continue the repair of the magnetic resonance device 1, thus the labor at the magnetic resonance device 1, without the necessary information. He therefore contacts with the telephone 5 located in the physician's practice 2 the central computer 6 of the manufacturer of the magnetic resonance device 1.

After contacting, the central computer 6 asks the technician 12 for his identity and for which products he needs information. Following this, the technician 12 communicates to the central computer 6 his personnel number as well as an identification assigned to the technician 12. Additionally, the technician 12 informs the central computer 6, that he needs information regarding the magnetic resonance device 1. These oral communications are recognized by the means of speech reproduction and speech analysis of the central computer 6.

Following this, the central computer 6 checks, if the technician 12 is authorized, to request information regarding the medico-technical devices offered by the manufacturer, by retrieving information from the database 8 with the appropriate computer program.

In the case of the present example of design, the technician 12 is authorized to request information regarding products and particularly regarding magnetic resonance devices of the manufacturer. This information is stored in the database 8. Afterwards, the central computer 6 checks with the computer program to which extent the technician 12 is authorized to request information regarding a magnetic resonance device of the type of the magnetic resonance device 1. This information is stored again in the database 8.

In the case of the present example of design, the technician 12 is authorized to receive technical data regarding the magnetic resonance devices of the manufacturer. The central computer 6 therefore asks the technician 12 by the means of speech reproduction and speech analysis 6a for the address of a communication terminal, to which information regarding the magnetic resonance device 1 should be transmitted.

Following this, the technician 12 communicates to the central computer 6 with the telephone 5, that he would like to have transmitted the requested information to a fax machine 15 and communicates to the central computer 6 the fax number assigned to the fax machine 15. The fax machine 15 is located, in the case of the present example of design, in the physician's practice of the physician 3.

Following this, the central computer 6 communicates a database 13 connected with the central computer 6, where several data records 13a to 13d are stored, which are each assigned to one of the types of the medico-technical devices offered by the manufacturer. The different data records 13a to 13d comprise among other things, each data regarding technical and non-technical data regarding the respective medico-technical device associated to it. Non-technical data is for example marketing relevant or business related data.

In the case of the present example of design, the data record 13a comprises data of magnetic resonance devices offered by the manufacturer, the data record 13b comprises data of computer tomography devices offered by the manufacturer, the data record 13c comprises data of the lithotripters offered by the manufacturer and the data record 13d comprises data of the x-ray devices offered by the manufacturer.

Because the technician 12 has requested information by the magnetic resonance device 1 and is authorized to request technical information by way of magnetic resonance devices, the central computer 6 requests the part of the data record 13a, assigned to the magnetic resonance devices, which comprises technical information, thus technical data regarding the magnetic resonance device 1. Afterwards, the central computer 6 forwards the requested part of the data record 13a with the fax number of the fax machine 15 to a fax and email server 14 which is connected with the central computer 6. The fax and email server 14 is connected to the communication network 4, so that it can transmit the part of the data record 13a, which was forwarded to the fax and email server, to the fax machine 15.

After the fax and email server 14 has transmitted the requested part of the data record 13a to the fax machine 15, the fax machine 15 prints a fax 15a, which comprises the technical information of the magnetic resonance device 1, so that the technician 12 can continue the repair on the magnetic resonance device 1.

In the case of the present example of design, the technician 12 transmits orally the data regarding him and the data regarding the magnetic resonance device 1. He can also enter this data with a keyboard 5a.

But the technician 12 can also contact the central computer 6 with the fax machine 15 and communicates with the fax machine 15 to the central computer 6 his identity, the data regarding the medico-technical device, about which he requires information, and the address of the communication terminal, to which he want to have the information transmitted.

It is also possible, that the technician 12 transmits this data by way of a computer 16 connected to the communication network 4. He can also transmit this data by a portable telephone 17 or send an SMS to the central computer 6.

The information requested by the technician 12 doesn't have to be necessarily transmitted to him by a fax 15a. This data can be transmitted to him particularly by the computer 16 as an email or to the portable telephone 17 as SMS. Other techniques, such as for example, techniques based on UMTS may be possible as well.

In the example of design described above, the central computer 6 transmits the mail and fax server 14 the data record 13 to, which should be sent to the fax machine 15. It is possible, though, that the central computer 6 and the fax and email server 14 are one machine.

The invention is not only limited to medico-technical devices but to general technical installations, as described in the introductory.

The person requesting the information does also not have to necessarily be a technician. The example of design described above is, by the way, to be understood only exemplary.

The invention being thus described, it will be obvious that the same may be varied in many ways. The variations are not to be regarded as a departure from the spirit and scope of the invention, and all such modifications as would be obvious to one skilled in the art are intended to be included within the scope of the following claims.

I claim:

1. A method for the request of data necessary for the execution of operations at a technical installation, showing the following procedure steps:
Contact with a first computer (6) with a first communication terminal (5, 15, 16, 17) by way of a communication network (4),
Receipt of data regarding the technical installation (1), data regarding the operator (12) and an address of a second communication terminal (15, 16, 17) by the first computer (6),
automatic contact of a database (13) by the first computer (6),
request of at least part of a data record (13a) stored in the database (13) and associated to the technical installation (1) and
transmission of the part of the data record (13a) requested by the first computer (6) to the second communication terminal (15, 16, 17).

2. The method according to claim 1, where the first communication terminal is a telephone (5, 17), a fax machine (15) or a second computer (16) connectable to the communication network (4).

3. The method according to claim 1, where the second communication terminal is the first fax machine (15), a second fax machine is the computer (16) connectable to the communication network (4) or is a third computer connectable to the communication network (4).

4. The method according to one of the claim 1, where the data regarding the technical installation (1) and/or the data regarding the operator (12) is transmitted by an identification transmittable with the first communication terminal (5, 15, 16, 17) to the first computer (6).

5. The method according to one of the claim 1, where the first computer (6) comprises means for the speech analysis, so that the data regarding the technical installation (1), the data regarding the operator (12) and/or the address of the communication terminal (5, 15-17) is transmitted orally to the first computer (6).

6. The method according to one of the claim 1, where the first computer (6) checks, if the person (12) is authorized to receive the data which are required for the execution of the operations at the technical installation (1).

7. The method according to one of the claim 1, where the part of the requested data record (13a) which is transmitted to the second communication terminal (5, 15-17) goes by the operator (12).

8. A device for the request of data required for the execution of operations at a technical installation, showing:
a database (13), where a data record (13a) associated to the technical installation (1) is stored, and
a first computer (4) which is connectable to a communication network (4) and is contactable with a first communication terminal (5, 15-17), which is designed in such a way, that it, based on received data from the first communication terminal (5, 15-17) by way of the technical installation (1), data regarding the operator (12) and an address of a second communication terminal (15-17), requests at least a part of the data record (13a) stored in the database (13) and transmits it to the second communication terminal (15-17).

9. The device according to claim 8, where the first communication terminal is a telephone (5, 17), a fax machine (15) or a second computer (16) connectable to the communication network.

10. The device according to claim 8, where the second communication terminal (1) is the first fax machine (15), a second fax machine is the second computer (16) connectable to the communication network (4) or a third computer connectable to the communication network (4).

11. The device according to one of the claim 8, where the data regarding the technical installation (1) and/or the data regarding the operator (12) is transmittable to the first computer (6) by a identification transmittable with the first communication terminal (5, 15-17).

12. The device according to claim 8, where the first computer (6) is designed in such a way, that it can interpret orally transmitted data to the first computer (6) by the technical installation (1), data regarding the operator (12) and/or the address of the second communication terminal (5, 15-17).

13. The device according to claim 8, where the first computer (6) is designed in such a way, that it automatically checks, if the operator (12) is authorized to request for the data required for the execution of the operations at the technical installation (1).

14. The device according to claim 8, where the first computer (6) is designed in such a way that, based on the data regarding the operator (12), it only requests that part of the data record (13a) and transmits it to the communication terminal (15-17) which is intended for the operator (12).
